(19) United States
(12) Patent Application Publication
(10) Pub. No.: US 2020/0146295 A1
(43) Pub. Date: May 14, 2020

(54) MIXTURES OF SABADILLA ALKALOIDS AND MACROLIDES AND USES THEREOF

(71) Applicant: McLaughlin Gormley King Company, Golden Valley, MN (US)

(72) Inventor: Robert A. Suranyi, Minneapolis, MN (US)

(21) Appl. No.: 16/739,610

(22) Filed: Jan. 10, 2020

Related U.S. Application Data
(63) Continuation of application No. 16/278,827, filed on Feb. 19, 2019, now abandoned.
(60) Provisional application No. 62/632,533, filed on Feb. 20, 2018.

(51) Int. Cl. A01N 43/90

(52) U.S. Cl. CPC A01N 43/90

(57) ABSTRACT

The present invention is directed to pesticidal mixtures comprising sabadilla alkaloids and at least one macrolide and methods of controlling pests by application of pesticidal mixtures comprising sabadilla alkaloids and at least one macrolide.

### FIELD OF THE INVENTION

The present invention is directed to pesticidal mixtures comprising sabadilla alkaloids and at least one macrolide and methods of controlling pests by application of pesticidal mixtures comprising sabadilla alkaloids and at least one macrolide.

### BACKGROUND OF THE INVENTION

Arthropod pests, including insects, ticks and mites, are one of the major threats to human welfare and exert continued stress on the food supply and transmit a broad array of medical and veterinary diseases. Synthetic insecticides played a significant role and in many ways ushered in modern agriculture and pest control. However, the widespread use of synthetic insecticides also created numerous environmental challenges. The acute effects of synthetic pesticides on professional applicators and other end users are well-known but the chronic long term human health effects can be equally serious. Further, the use of synthetic insecticides has led to the development of resistant insect populations. Insecticide resistance is a complex phenomenon underlined by a diverse array of physiological mechanisms. Major mechanisms that are responsible for the development of insecticide resistance are metabolic detoxification, target site mutation, reduced cuticular penetration and behavioral avoidance.

Integrated Pest Management (“IPM”) is a holistic approach to pest management. A fundamental aspect of insecticide utilization under the broader framework of IPM is the management of insecticide resistance (IRM) by the utilization of insecticide combinations that reduce the rate of resistance development. A combination of insecticides with different modes of action is fundamentally a concept based upon the idea of redundant killing of target insect populations. Insect within the population adapted to one of the active ingredient in the combination product will still be killed by the other active ingredient. This combination effect will result in an overall greater reduction in population size and be more likely to cause eradication of the entire population. Mixtures can also reduce the amount of pesticides applied in the environment and the environmental impact associated with pesticide applications.

Most botanical insecticides are readily biodegradable and significantly less harmful to the environment and users than synthetic insecticides. The very short environmental persistence, usually less than 24 hours, of plant derived insecticides is favorable to the survival of non-target, beneficial parasites and predators which are important components of IPM. Unlike conventional insecticides which are typically based on a single active ingredient, plant derived insecticides usually comprise an array of chemical compounds that affect both behavioral and physiological functions of the target arthropods. The probability of pest resistance developing to plant derived insecticides is less than that for synthetic pesticides because these mixtures may have a variety of modes of action.

Helminths include nematodes, cestodes and trematodes. Nematodes, better known as roundworms, and more specifically hookworms, pinworms, whipworms, heart worms etc., are found all over the earth in almost every environment. In fact, nematodes account for about 80% of all individual animals on earth. Over half of nematode species are parasitic and present a significant problem to both plant and animal health. One particularly costly group of nematodes is those that form root-knots in plants such as soybean, corn, sugar beet, potato and tomato crops.

Root-knot infections can affect yield and aesthetic value of these crop plants leading to significant financial loss to growers. These nematodes also pose quarantine issues that limit the commercial potential of a given growing region and/or grower. Currently, there is a dearth of safe and effective treatments for root-knot disease.

One effective naturally derived pesticide is found in the tissues of many of the plants of the genus Schoenocaulon, commonly referred to as sabadilla. The species with the longest history of use, and the most readily available, is Schoenocaulon officinale. The plant is indigenous to Central and South America and its seeds have been used for centuries for their insecticidal properties. The seeds contain several alkaloids including veratridine and cevadine, both of which are known to be active against arthropods.

Macrolides are a naturally occurring class of products known to effectively control arthropod, parasitic helminth and parasitic fungal pests. Two commonly used groups of macrolides include avermectins and the closely related milbemycins, each of which are produced by Streptomyces spp. Avermectins and milbemycin have a similar mechanism of action as each open glutamate-sensitive chloride channels in neural cells of invertebrates blocking signal transfer. Avermectins include abamectin, doramectin, emamectin benzoate, eprinomectin, ivermectin, and selamectin. Milbemycins include lepimectin, milbemectin, milbemectin oxime and moxidectin. While macrolides are effective, macrolide resistance is becoming an increasing issue in agriculture and veterinary medicine.

Thus, there is a need in the art for pesticide combinations that contain pesticides that decrease health concerns to humans and also decrease the risk of the development of pesticide resistance.

### SUMMARY OF THE INVENTION

In one aspect, the present invention is directed to pesticidal mixtures of sabadilla alkaloids and at least one macrolide.

In another aspect, the present invention is directed to methods of controlling pests comprising applying an effective amount of a mixture of sabadilla alkaloids and at least one macrolide.

In a preferred aspect, the sabadilla alkaloids are derived from Schoenocaulon officinale.

### DETAILED DESCRIPTION OF THE INVENTION

Applicant unexpectedly discovered that pesticidal mixtures of sabadilla alkaloids and at least one macrolide provided enhanced pesticidal activity compared to either pesticide alone.

Further, Applicant discovered that pesticidal mixtures of sabadilla alkaloids and at least one macrolide were capable of controlling a large variety of pests.

The present invention is directed to pesticidal mixtures comprising an effective amount of sabadilla alkaloids and at least one macrolide.

Sabadilla alkaloids may be derived from any species of Schoenocaulon. The genus Schoenocaulon includes the following species: S. calcicola, S. caricifolium, S. comatum, S. conzattii, S. dubium (alt. S. gracile), S. framei, S. ghiesbreghtii (alt. S. drummondii, S. yucatanense), S. ignigenum, S. intermedium, S. jaliscense, S. macrocarpum (alt. S. lauricola), S. madidorum, S. megarrhizum, S. mortonii, S. oaracense, S. obtusum, S. officinale, S. pellucidum, S. plumosum, S. pringlei, S. rzedowskii, S. tenorioi, S. tenue, S. tenuifolium, S. texanum, and S. tigrense. In a preferred embodiment the sabadilla alkaloids are derived from S. officinale. In another preferred embodiment the sabadilla alkaloids are veratridine and cevadine.

Macrolides suitable for use in the present invention include, but are not limited to avermectins and milbemycins. In a preferred embodiment the at least one macrolide of the present invention is selected from a group consisting of abamectin (avermectin B1), doramectin, emamectin, eprinomectin, ivermectin, selamectin, lepimectin, milbemectin, milbemectin oxime and moxidectin, salts thereof and isomers thereof. In a more preferred embodiment, the macrolide is abamectin.

As used herein, all numerical values relating to amounts, weight percentages and the like are defined as “about” or “approximately” each particular value, namely, plus or minus 10%. For example, the phrase “at least 5% by weight” is to be understood as “at least 4.5% to 5.5% by weight.” Therefore, amounts within 10% of the claimed values are encompassed by the scope of the claims.

As used herein, w/w denotes weight by weight of the total mixture.

The term “effective amount” means the amount of the formulation that will control the target pest. The “effective amount” will vary depending on the mixture concentration, the type of pest(s) being treated, the severity of the pest infestation, the result desired, and the life stage of the pest during treatment, among other factors. Thus, it is not always possible to specify an exact “effective amount.” However, an appropriate “effective amount” in any individual case may be determined by one of ordinary skill in the art.

In a preferred embodiment, the ratio of sabadilla alkaloids to at least one macrolide is from about 100:1 to about 1:5, more preferably from about 20:1 to about 1:2 and most preferably from about 17.5:1 to about 1:1.2. Alternatively, the ratio of sabadilla alkaloids to at least one macrolide is from about 100:1 to about 2:1, from about 20:1 to about 2:1 and from about 17.5:1 to about 3.7:1.

The present invention is further directed to methods of controlling a pest comprising applying a pesticidal mixture comprising an effective amount of sabadilla alkaloids and at least one macrolide to the pest or the pest's environment.

In a preferred embodiment, the pest is selected from an insect, a mite, a tick and a fungus.

In an embodiment, the pest controlled is selected from the group consisting of flies (Diptera), beetles (Coleoptera), aphids (Homoptera), whiteflies (Hemiptera), capterpillars/worms (Lepidoptera) and mites (Acari).

In a more preferred embodiment, the pest controlled is selected from the group consisting of greenhouse whitefly (Trialeurodes vaporariorum), silverleaf whitefly B biotype (Bemisia tabaci B Biotype), silverleafwhitefly Q biotype (Bemisia tabaci Q Biotype), twospotted spider mites (Tetranychus urticae) and broad mite (Polyphagotarsonemus latus).

The pesticidal mixtures of the present invention can be applied by any convenient means. Those skilled in the art are familiar with the modes of application including spraying, brushing, soaking, in-furrow treatments, pressurized liquids (aerosols), fogging or side-dressing.

In a preferred embodiment, sabadilla alkaloids are applied to the pest or the pest's environment at a rate necessary to control the pest. In a preferred embodiment the rate is from about 1 to about 1,000 grams per hectare (“g/HA”), preferably from about 10 to about 700 g/HA and most preferably from about 22 to about 105 g/HA.

In a preferred embodiment, the at least one macrolide is applied to the pest or the pest's environment at a rate from about 1 to about 1,000 g/HA, preferably from about 1 to about 100 g/HA and most preferably from about 5 to about 30 g/HA.

In another preferred embodiment, pesticidal mixtures of the present invention comprise from about 0.01% to about 50% w/w sabadilla alkaloids.

In another preferred embodiment, pesticidal mixtures of the present invention comprise from about 0.01% to about 50% w/w of at least one macrolide.

As used herein, “control” a pest or “controlling” pest(s) refers to killing, incapacitating, repelling, or otherwise decreasing the negative impact of the pest on plants or animals to a level that is desirable to the grower or animal.

As used herein, “pest's environment” refers to any area that the pest is present during any life stage. One environment likely to be treated by the methods of the present invention includes the plants that the pest is living on and the surrounding soil. The pest's environment may also include harvested plants, gardens, fields, greenhouses, or other buildings, and various indoor surfaces and structures, such as furniture including beds, and furnishings including books, clothing, etc.

The articles “a,” “an” and “the” are intended to include the plural as well as the singular, unless the context clearly indicates otherwise. For example, the methods of the present invention are directed to controlling “pest” but this can include control of a multiple pests (such as a more than one insect or more than one insect species).

The following examples are intended to illustrate the present invention and to teach one of ordinary skill in the art how to use the extracts of the invention. They are not intended to be limiting in any way.

### EXAMPLES

### Example 1—Whiteflies

In this study, the response of whiteflies to application of a 3.7:1, 4.0:1, 17.5:1 and 1:1.2 1 ratio of sabadilla (S. officinale) alkaloids to at least one macrolide will be observed. Specifically, sabadilla alkaloids and at least one macrolide will be applied to the pest at the respective rates of: 1) 22 g/HA and 6 g/HA; 2) 105 g/HA and 6 g/HA; 3) 22 g/HA and 26 g/HA; and 4) 105 g/HA and 26 g/HA.

The results of the study are predicted to show more than an additive effect. One can determine that the response is synergistic using the following formula: % Cₑₓₚ=A+B−(AB/100).

### Example 2—Spider Mites

In this study, the response of spider mites to application of a 3.7:1, 4.0:1, 17.5:1 and 1:1.2 1 ratio of sabadilla (S. officinale) alkaloids to at least one macrolide will be observed. Specifically, sabadilla alkaloids and at least one macrolide will be applied to the pest at the respective rates of: 1) 22 g/HA and 6 g/HA; 2) 105 g/HA and 6 g/HA; 3) 22 g/HA and 26 g/HA; and 4) 105 g/HA and 26 g/HA.

The results of the study are predicted to show more than an additive effect. One can determine that the response is synergistic using the following formula: % Cₑₓₚ=A+B−(AB/100).

What is claimed is:

1. A pesticidal mixture comprising an effective amount of sabadilla alkaloids and at least one macrolide.

2. The mixture of claim 1, wherein the sabadilla alkaloids are derived from Schoenocaulon officinale.

3. The mixture of claim 1, wherein the sabadilla alkaloids are veratridine and cevadine.

4. The mixture of claim 1, wherein the at least one macrolide is selected from an avermectin and a milbemycin.

5. The mixture of claim 1, wherein the at least one macrolide is selected from the group abamectin, doramectin, emamectin, eprinomectin, ivermectin, selamectin, lepimectin, milbemectin, milbemectin oxime, moxidectin, salts thereof and isomers thereof.

6. The mixture of claim 1 wherein the at least one macrolide is abamectin.

7. The mixture of claim 1 further comprising one or more excipients selected from the group consisting of solvents, anti-caking agents, stabilizers, defoamers, slip agents, humectants, dispersants, wetting agents, thickening agents, emulsifiers, penetrants, adjuvants, polymers, propellants and/or preservatives.

8. A method of controlling a pest comprising applying a pesticidal mixture comprising an effective amount of sabadilla alkaloids and at least one macrolide to the pest or the pest's environment.

9. The method of claim 8, wherein the pest is at least one of an insect, a mite, a tick, a helminth and a fungus.

10. The method of claim 8, wherein the pest is selected from the group consisting of flies (Diptera), beetles (Coleoptera), aphids (Homoptera), whiteflies (Hemiptera), capterpillars/worms (Lepidoptera) and mites (Acari).

11. The method of claim 8, wherein the pest is selected form the group consisting of greenhouse whitefly (Trialeurodes vaporariorum), silverleafwhitefly B biotype (Bemisia tabaci B Biotype), silverleaf whitefly Q biotype (Bemisia tabaci Q Biotype), twospotted spider mites (Tetranychus urticae) and broad mite (Polyphagotarsonemus latus).

12. The method of claim 8, wherein the sabadilla alkaloid is applied at a rate from about 1 to about 1,000 grams per hectare.

13. The method of claim 8, wherein the sabadilla alkaloid is applied at a rate from about 10 to about 700 grams per hectare.

14. The method of claim 8, wherein the sabadilla alkaloid is applied at a rate from about 22 to about 105 grams per hectare.

15. The method of claim 8, wherein the at least one macrolide is applied at a rate from about 1 to about 1,000 grams per hectare.

16. The method of claim 8, wherein the at least one macrolide is applied at a rate from about 1 to about 100 grams per hectare.

17. The method of claim 8, wherein the at least one macrolide is applied at a rate from about 5 to about 30 grams per hectare.
